(19) United States
(12) Patent Application Publication
(10) Pub. No.: US 2026/0226279 A1
(43) Pub. Date: Aug. 6, 2026

(54) PROCESS FOR PROVIDING LOW GLOSS COATINGS

(71) Applicant: Covestro (Netherlands) B.V., Geleen (NL)

(72) Inventors: Jurgen SCHEERDER, Buren (NL); Ilse VAN CASTEREN, Veldhoven (NL); Daan HUISMAN, Eindhoven (NL); Pascal VAN DEN THILLART, Rosmalen (NL); Johan Franz Gradus Antonius JANSEN, Geleen (NL); Michael VILLET, Maastricht (NL); Ronald TENNEBROEK, Dongen (NL)

(21) Appl. No.: 19/103,374

(22) PCT Filed: Aug. 22, 2023
(86) PCT No.: PCT/EP2023/073023

§ 371 Date: Feb. 12, 2025

(30) Foreign Application Priority Data
Aug. 24, 2022 (EP) 22191845.1
Aug. 24, 2022 (EP) 22191847.7
Aug. 24, 2022 (EP) 22191849.3
Aug. 24, 2022 (EP) 22191850.1

(51) Int. Cl. C09D 4/06; C09D 5/02; C09D 125/14; C09D 133/06

(52) U.S. Cl. CPC C09D 4/06; C09D 5/022; C09D 125/14; C09D 133/064

(57) ABSTRACT

The present invention relates to a process process for producing a coating from an aqueous, radiation-curable coating composition, wherein the process comprises the steps in the sequence (1) to (4):
(1) applying an aqueous, radiation-curable coating composition on a surface of a substrate,
(2) drying the aqueous, radiation-curable coating composition, affording an at least partially dried coating composition,
(3) irradiating the at least partially dried coating composition with UV light having a wavelength≤220 nm under inert atmosphere, followed by
(4) irradiating with UV light having a wavelength≥300 nm or with E-beam,
wherein the aqueous, radiation-curable coating composition is a dispersion comprising:
(A) at least one water-dispersed vinyl polymer system (A), wherein
the polymer system (A) comprises one or more vinyl polymer with a glass transition temperature Tg of less than or equal to 77° C. in an amount of at least 50 wt. %, based on the amount of the polymer system (A), wherein the Tg is determined with Differential Scanning Calorimetry as described in the description,
the polymer system (A) is essentially free of radiation-curable, ethylenically unsaturated bonds, and
the polymer system (A) has an acid value from 5 to 105 mg KOH/gram (A),
(B) at least one radiation-curable diluent (B) with a molar mass less than 750 g/mol and with an acrylate functionality of 2 or 3, and
(C) water and optionally organic solvent, whereby the optional organic solvent is present in an amount of at most 30 wt. %, based on the total amount of water and organic solvent,
wherein
the amount of (A) is from 30 to 75 wt. % and the amount of (B) is from 25 to 70 wt. %, based on the total amount of (A) and (B).

The present invention relates to the field of aqueous vinyl polymer coating compositions which produce coatings that have a high matt (i.e. low gloss) finish.

Aqueous vinyl polymer, in particular acrylic copolymer, coating compositions are widely used in the coating industry. However, usually upon drying of the aqueous coating composition glossy surfaces are obtained. “Low gloss” surfaces give products a much sought-after aesthetic effect, especially in the wood-furniture, flooring and wall covering industry, because they can create a very natural appearance that contribute to giving greater emphasis to the materiality of the article. At present, the creation of matte surfaces frequently involves the use of coating products the formulation of which contains matting agents made from organic and/or inorganic substances which, by positioning themselves on the coated surface and/or emerging on it, are able to act on the degree of reflection of light, giving the observer the visual sensation of a low gloss surface. However, the use of matting agents produces a worsening of the surface performance of the coating since they are not involved in the polymerization process. Further there is a tendency for the matting agent to migrate to the coating surface after application and consequently the matting agent might get lost upon mechanical deformation, caused by for example scratch, resulting in an increase of gloss. The resistance to typical household chemicals, such as coffee, is also strongly reduced by the use of matting agents. Long-term action of these household chemicals leads at least to a reduction in quality of the coating and possibly even to its complete destruction.

The object of the present invention is to provide a method for obtaining a low gloss coating from an aqueous vinyl polymer dispersion without having to use matting agents.

According to the invention there is provided a process for producing a coating from an aqueous, radiation-curable coating composition, wherein the process comprises the steps in the sequence (1) to (4):
(1) applying an aqueous, radiation-curable coating composition on a surface of a substrate,
(2) drying the aqueous, radiation-curable coating composition, affording an at least partially dried coating composition,
(3) irradiating the at least partially dried coating composition with UV light having a wavelength s 220 nm under inert atmosphere, followed by
(4) irradiating with UV light having a wavelength 300 nm or with E-beam,
wherein the aqueous, radiation-curable coating composition is a dispersion comprising:
(A) at least one water-dispersed polymer system (A) of at least one vinyl polymer, wherein
   the polymer system (A) comprises vinyl polymer with a glass transition temperature T_{g} of less than or equal to 77° C. in an amount of at least 50 wt. %, based on the amount of the polymer system (A), wherein the T_{g} is determined with Differential Scanning Calorimetry as described in the description,
   the polymer system (A) is essentially free of radiation-curable, ethylenically unsaturated bonds, and
   the polymer system (A) has an acid value from 5 to 105 mg KOH/gram (A),
(B) at least one radiation-curable diluent (B) with a molar mass less than 750 g/mol and with an acrylate functionality of from 2 to 3, and
(C) water and optionally organic solvent, whereby the optional organic solvent is present in an amount of at most 30 wt. %, based on the total amount of water and organic solvent,
wherein the amount of (A) is from 30 to 75 wt. % and the amount of (B) is from 25 to 70 wt. %, based on the total amount of (A) and (B).

It has surprisingly been found that the method of the present invention makes it possible to obtain low gloss coatings from aqueous, radiation-curable vinyl polymer dispersions as defined herein, without the use of matting agents.

It has furthermore surprisingly been found that, without the use of matting agent, the method of the present invention, which method includes the pre-treatment of the coating composition with UV light with a wavelength s 220 nm (further also referred to as the excimer radiation step), makes it possible to obtain low gloss coatings from aqueous, radiation-curable vinyl polymer dispersions as defined herein, with improved coffee and/or water resistance compared to when the dispersions contain matting agent and this while the vinyl polymer system essentially free of radiation-curable, ethylenically unsaturated bonds. More in particular with the process of the invention a coating can be obtained with a gloss measured at 20° geometry of angle lower than 10 gloss units and preferably with a gloss measured at 60° geometry of angle lower than 40 gloss units (further referred to as low gloss), more preferably with a gloss measured at 60° geometry of angle lower than 30 gloss units, more preferably with a gloss measured at 60° geometry of angle lower than 20 gloss units. The aqueous, radiation-curable coating composition according to the invention allows to obtain a difference in gloss measured at 60° geometry of angle with and without the excimer radiation step of at least 30 gloss units, preferably of at least 40 gloss units, more preferably of at least 50 gloss units, more preferably of at least 60 gloss units.

An additional advantage of the present invention is that with the present invention low gloss coatings with improved nail scratch resistance can be obtained compared to when the dispersions contain matting agent.

An additional advantage of the present invention is that handling of matting agents is not required, which is advantageous since matting agents have a large surface area and contain a large proportion of dust-forming small particles that may create exposure and explosion hazards. An additional advantage of not having to use matting agents for obtaining low gloss coatings is that coating compositions with less or no settling and thus improved storage stability can be achieved. An additional advantage of the method of the present invention is that coatings with a significantly higher smoothness can be obtained compared to when the coatings contained matting particles.

WO-A-2013/092521 describes a process for the production of homogeneous matted coatings on flat surfaces based on a so-called 100% radiation-curable coating compositions. In this method, first, the 100% radiation-curable coating composition, that contains a low molecular weight, radiation-curable oligomer as binder and optionally one or more reactive thinners to reduce the viscosity, is coated on the surface of a flat substrate with a spiral blade. This wet paint layer is subsequently irradiated with UV light with a wavelength of from 200 to 420 nm and a radiation dose of 25 to 120 mJ/cm² resulting in partial gelation of the coating composition. Then the so-obtained coating is irradiated with UV light from an Excimer lamp having a wavelength from 120 nm to 230 nm under inert gas, followed by finish curing using conventional UV emitters. A 100% radiation-curable coating composition refers to a coating composition having a solids content of 100 wt. %. 100% radiation-curable coating compositions are homogeneous systems having only one phase, while the aqueous, radiation-curable vinyl polymer coating compositions as defined herein are dispersions having at least two phases where one phase contains discrete particles (colloidally dispersed particles) distributed throughout an aqueous medium, the particles being the disperse phase and the aqueous medium the continuous phase.

WO-A-2013/092521 does not teach that low gloss coatings could be obtained from aqueous coating compositions, let alone from aqueous, radiation-curable vinyl polymer dispersions as defined herein and is furthermore silent on stain resistances of the cured coating.

A further disadvantage of the method described in WO-A-2013/092521 is that the viscosity of 100% radiation-curable coating composition is usually high making some application techniques, such as spraying, for example, difficult or impossible to use to apply the coating composition to the substrate. Spraying applications can advantageously be used to apply coating composition on substrates with more complex shapes, such as for example furniture or decorative frames. The viscosity of 100% radiation-curable coating composition can be reduced by adding monofunctional diluents with low molecular weight, resulting in that a viscosity can be obtained that allows depositing the radiation-curable coating composition on a substrate by spraying. However, applying of 100% radiation-curable coating composition by spraying inherently results in a coating with high coating thickness.

An additional advantage of the use of aqueous, radiation-curable vinyl polymer dispersions as defined herein is that the viscosity can be steered by adjusting the solids with water, resulting in that with the process of the invention coatings can also easily be applied by spraying.

An additional advantage of the fact that the aqueous, radiation-curable vinyl polymer dispersions as defined herein are more easily spray-applied is that the method of the invention also makes it possible to obtain low gloss coatings on more complex shaped articles such as, for example, a decorative frame with a more uniform degree of gloss of the coated article.

An additional advantage of the use of aqueous, radiation-curable coating composition as defined herein is that coatings with a lower thickness, such as for example a coating thickness of 50 micron or even less, can be rendered low gloss using the method of the invention. A further advantage of the invention is that the gloss level of the coating can be tuned with the residual water and/or organic solvent content that is present in the at least partially dried coating composition.

It has furthermore surprisingly been found that that with the coating composition as claimed a low gloss coating can be obtained in only 2 irradiation steps (i.e. step (3) and (4)), in particular for coatings with a wet thickness (before drying) of at most 300 micron, or at most 250 micron, or at most 200 micron or at most 175 micron, in particular of at most 150 micron, more in particular of at most 125 micron, more in particular of at most 100 micron and more in particular of at most 75 micron. WO-A-2013/092521 teaches that an additional partial gelation irradiation step is needed prior to the excimer radiation step (step (3) of the process of the present invention) and the finish curing step (step (4) of the process of the present invention) and thus WO-A-2013/092521 teaches that three irradiation steps are needed to obtain a low gloss/matte coating with a homogeneous surface structure, see in particular Table 2.

The aqueous, radiation-curable coating composition used in the process of the invention comprises vinyl polymer in dispersed form, i.e. the composition comprises dispersed particles of vinyl polymer.

A dispersion refers to a system with at least two phases where one phase contains discrete particles (colloidally dispersed particles) distributed throughout a bulk substance, the particles being the disperse phase and the bulk substance the continuous phase. The continuous phase of an aqueous dispersion is provided at least in part by water. Preferably the continuous phase of the dispersion of the invention comprises at least 75 wt. %, more preferably at least 80 wt. %, even more preferably at least 90 wt. % of water (relative to the continuous phase).

The aqueous coating composition used in the process of the invention is radiation-curable. By radiation-curable is meant that radiation is required to initiate crosslinking of the dispersion. The aqueous coating composition used in the process of the invention contains ethylenically unsaturated (C═C) bond functionality which under the influence of irradiation, preferably in combination with the presence of a (photo)initiator, can undergo crosslinking by free radical polymerisation.

As used herein, the acrylate functionality of a compound is the number of acrylate functional groups per molecule of the compound.

An acrylate functional group has the following formula:

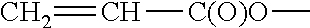

For all upper and/or lower boundaries of any range given herein, the boundary value is included in the range given, unless specifically indicated otherwise. Thus, when saying from x to y, means including x and y and also all intermediate values.

### Polymer System (A)

The polymer system (A) comprises one or more vinyl polymers with a glass transition temperature T_{g} of less than or equal to 77° C. in an amount of at least 50 wt. %, preferably at least 55 wt. %, more preferably at least 60 wt. %, more preferably at least 65 wt. %, based on the amount of the polymer system (A). The glass transition temperature T_{g} is determined with Differential Scanning Calorimetry as described further herein. Accordingly, the amount of vinyl polymer(s) with a glass transition temperature T_{g} of less than or equal to 77° C. present in the vinyl polymer system is from 50 to 100 wt. %, preferably from 55 to 100 wt. %, more preferably from 60 to 100 wt. %, even more preferably from 65 to 100 wt. %; and the amount of vinyl polymer(s) with a glass transition temperature T_{g} higher than 77° C. that is allowed to be present in the vinyl polymer system is from 0 to 50 wt. %, preferably from 0 to 45 wt. %, more preferably from 0 to 40 wt. %, even more preferably from 0 to 35 wt. %, whereby the summed amount of vinyl polymers with a glass transition temperature T_{g} of less than or equal to 77° C. and of vinyl polymers with a glass transition temperature T_{g} higher than 77° C. is preferably 100 wt. %. Thus, the polymer system preferably consists of vinyl polymers with a glass transition temperature T_{g} of less than or equal to 77° C. and optionally vinyl polymers with a glass transition temperature T_{g} higher than 77° C.

The polymer system (A) present in the aqueous, radiation-curable coating composition to be used in the present invention has a theoretical acid value from 5 to 105 mg KOH/gram (A).

The polymer system (A) preferably has an acid value lower than 95 mg KOH/gram (A), more preferably lower than 85 mg KOH/gram (A), even more preferably lower than 75 mg KOH/gram (A).

As used herein, the acid value of the polymer system (A) is the theoretical acid value and is calculated according to the formula AV=((gram acid monomer per gram of total amount of monomers used to prepare the polymer system (A)/molecular weight acid monomer)*56.1)*1000 and is denoted as mg KOH/gram (A).

The polymer system (A) present in the aqueous, radiation-curable coating composition to be used in the present invention is essentially free of radiation-curable, ethylenically unsaturated bonds. As used herein, a polymer system (A) that is essentially free of radiation-curable, ethylenically unsaturated bonds means that the radiation-curable ethylenically unsaturated bond concentration (also referred to as the C═C bond concentration) of the polymer system (A) present in the aqueous, radiation-curable coating composition of the present invention is less than 0.50 meq C═C per g of polymer system (A), preferably less than 0.40 meq C═C per g of polymer system (A), more preferably less than 0.30 milliequivalents C═C per g of polymer system (A), more preferably less than 0.20 milliequivalents C═C per g of polymer system (A), more preferably less than 0.10 milliequivalents C═C per g of polymer system (A). As used herein, the amount of radiation-curable, ethylenically unsaturated bonds in the polymer system (A) is measured by iodometric titration, i.e. is measured by a titration method following the addition of a fixed excess amount of dodecyl mercaptane solution (0.25N) on said unsaturated groups (isopropyl alcohol IPA/toluene as solvent and KOH as catalyst); Allow to react for 3 minutes (base catalysed Michael addition of mercaptane to double bonds). Afterwards acetic acid is added to neutralize the KOH and an excess of iodine solution (0.1N) on dodecylmercaptane is added. The residual iodine is then titrated with sodium thiosulfate using a platinum electrode. Most preferably, the polymer system (A) does not contain radiation-curable ethylenically unsaturated bonds.

By a vinyl polymer is meant generally herein a polymer derived from the addition polymerisation (normally by a free-radical process) of at least one olefinically unsaturated monomer. By a vinyl monomer is therefore meant herein an olefinically unsaturated monomer.

The at least one vinyl polymer of the vinyl polymer system is preferably obtained by solution, emulsion or suspension polymerization. In case vinyl polymer is obtained by solution polymerization, the applied solvent, preferably a volatile solvent, is removed during and/or after emulsification of vinyl polymer. Preferably the process to prepare the at least one vinyl polymer is free of organic solvent. As such, the at least one vinyl polymer is preferably obtained by emulsion or suspension polymerization. Most preferably the at least one vinyl polymer is obtained by emulsion polymerization, preferably the at least one vinyl polymer is obtained in an aqueous emulsion polymerisation process. Such an aqueous emulsion polymerisation process is, in itself, well known in the art and need not be described in great detail. Suffice to say that such a process involves polymerizing the monomers in an aqueous medium and conducting polymerisation using a free-radical yielding initiator and (usually) appropriate heating (e.g. 30 to 120° C.) and agitation (stirring) being employed. The aqueous emulsion polymerisation can be effected using one or more conventional emulsifying agents, these being surfactants. Anionic, non-ionic, and anionic-non-ionic surfactants can be used, and also combinations of the three types; cationic surfactants can also be used.

In case the at least one vinyl polymer is prepared via emulsion polymerization, the radical polymerization to obtain vinyl copolymer (A) is conducted using a free radical initiator, appropriate heating and agitation (stirring). The polymerisation can employ conventional free radical initiators [e.g. hydrogen peroxide, t-butyl-hydroperoxide, cumene hydroperoxide, persulphates such as ammonium, potassium and sodium salts of persulphate; redox systems may be used; combinations such as t-butyl hydroperoxide isoascorbic acid and FeEDTA are useful; the amount of initiator, or initiator system, is generally 0.05 to 3% based on the weight of total monomers charged. The molecular weight of vinyl copolymer (A) can be controlled by the use of well-known chain transfer agents. Preferred chain transfer agents can include mercaptanes and alkyl halogenides. More preferred, the chain transfer agent is selected from the group of lauryl mercaptane, 3-mercapto propionic acid, i-octyl thioglycolate, mercaptoethanol, tetrabromo methane, or tribromo methane. Most preferred the chain transfer agent is a mercaptane, selected from the group of lauryl mercaptane, 3-mercapto propionic acid, i-octyl thioglycolate, and mercaptoethanol.

The polymerization of the vinyl monomers to form the polymer system (A) can be run in different ways. One can envisage straight emulsions, with only one monomer feed, sequential polymers resulting in a phase separated particle morphology, and oligomer-polymer emulsions where preferably one of the polymer phases contains significantly more acid functionality than the other phase(s).

The polymer system may have a phase separated particle morphology obtained by the polymerization of at least a first monomer feed and a different second monomer feed. The polymer system (A) preferably comprises at least two vinyl polymers. In case the polymer system (A) comprises at least two vinyl polymers, preferably, the at least two vinyl polymers differ in glass transition temperature (T_{g}) by at least 20° C., more preferably by at least 30° C., more preferably by at least 40° C., more preferably by at least 50° C., more preferably by at least 60° C., and preferably by at most 200° C., more preferably by at most 150° C. In an embodiment of the invention, the polymer system (A) comprises at least two vinyl polymers with a difference in acid value, whereby one vinyl polymer has an acid value of at least 13 mg KOH/g of vinyl polymer and at least one of the other vinyl polymers preferably has an acid value of no more than 13 mg KOH/g of vinyl polymer.

An emulsion polymerisation for making the at least one vinyl polymer may be carried out using an “all-in-one” batch process (i.e. a process in which all the materials to be employed are present in the polymerisation medium at the start of polymerisation) or a semi-batch process in which one or more of the materials employed (usually at least one of the monomers) is wholly or partially fed to the polymerisation medium during the polymerisation. In-line mixing for two or more of the materials employed may also be used.

The pH of the final polymer emulsion comprising the polymer system (A) is preferably between 5 and 9, more preferred between 7 and 9. In the case of an emulsion polymerization process, the pH is raised preferably during the monomer feed or at the end of the polymerization using ammonia, organic amines or inorganic bases. Preferred bases are ammonia, dimethyl ethanol amine, and lithium, sodium, or potassium hydroxide salts. The most preferred base is ammonia.

The polymer system (A) preferably has a weight-average molecular weight M_{w} of at least 5,000 g/mol, more preferably of at least 10,000 g/mol, even more preferably at least 20,000 g/mol, even more preferably at least 30,000 g/mol. The upper limit of the weight-average molecular weight is not critical, but is preferably of at most 1,000,000 g/mol, more preferably of at most 500,000 g/mol, even more preferably at most 250,000 g/mol. The weight-average molecular weight M_{w} is determined as described further herein.

The vinyl polymer(s) of the vinyl polymer system (A) is preferably an acrylic polymer. The term acrylic polymer as used herein denotes a polymer obtained by polymerisation of at least one polymer precursor comprising an acrylate (—HC═CHC(═O)O—) and/or a methacrylate (—HC═C(CH3)C(═O)O—) moiety, resulting in an acrylic polymer comprising —(CH2-CHC(═O)O—)— and/or a —(CH2-C(CH3)C(═O)O—)— moieties. The acrylic polymer may comprise other moieties including arylalkylenes such as styrene, although in an embodiment of the invention it is preferred that the compositions are substantially free of arylalkylenes.

The polymer system (A) preferably comprises
(A1) carboxylic acid functional olefinically unsaturated monomer, and
(A2) olefinically unsaturated monomer, different from (A1).

Monomers (A1) are preferably selected from the group consisting of itaconic acid, itaconic anhydride, mono-alkylesters of itaconic acid, mono-aryl esters of itaconic acid, acrylic acid, methacrylic acid, β-carboxyethyl acrylate and combinations thereof, more preferably, monomer (A1) is acrylic acid and/or methacrylic acid and most preferably, monomer (A1) is methacrylic acid.

Monomers (A2) are preferably selected from the group consisting of acrylates, methacrylates, arylalkylenes, itaconates and any mixture thereof. Preferably at least 30 weight percent, more preferably at least 40 weight percent, more preferably at least 50 weight percent, more preferably at least 60 weight percent and even more preferably at least 70 weight percent of the total amount of monomers (A2) is selected from the group consisting of methyl methacrylate, n-butyl acrylate, n-butyl methacrylate, 2-ethyl hexyl acrylate, 2-octyl acrylate, styrene and mixtures of two or more of said monomers. Preferably at least 30 weight percent, more preferably at least 40 weight percent, more preferably at least 50 weight percent, more preferably at least 60 weight percent and even more preferably at least 70 weight percent of the total amount of monomers (A2) is selected from the group consisting of methyl methacrylate, n-butyl acrylate, n-butyl methacrylate, 2-ethyl hexyl acrylate, 2-octyl acrylate and mixtures of two or more of said monomers.

### Radiation-Curable Diluent (B)

The radiation-curable coating composition comprises one or more radiation-curable diluents (B) with a molar mass less than 750 g/mol and with an acrylate functionality of 2 or 3. In an embodiment, the radiation-curable coating composition comprises one or more radiation-curable diluent (B) with a molar mass less than 750 g/mol and with an acrylate functionality of 2. In another embodiment, the radiation-curable coating composition comprises one or more radiation-curable diluent (B) with a molar mass less than 750 g/mol and with an acrylate functionality of 3. In still another embodiment, the radiation-curable coating composition comprises one or more radiation-curable diluent (B) with a molar mass less than 750 g/mol and with an acrylate functionality of 2 and one or more radiation-curable diluent (B) with a molar mass less than 750 g/mol and with an acrylate functionality of 3.

The molar mass of the radiation-curable diluents (B) is calculated from their corresponding molecular formulas indicating the numbers of each type of atom in the radiation-curable diluent. Thus, the molar mass of (B) is the calculated molar mass obtained by adding the atomic masses of all atoms present in the structural formula of the compound.

Said one or more acrylate diluents (B) have a molar mass less than 750 g/mol, preferably less than 650 g/mol, more preferably a molar mass of at most 500 g/mol, more preferably of at most 450 g/mol. Said one or more acrylate diluents (B) preferably have a molar mass of at least 125 g/mol, preferably of at least 150 g/mol, more preferably of at least 175 g/mol and even more preferably of at least 200 g/mol.

Preferred examples of said one or more acrylate diluents (B) with an acrylate functionalilty of 2 are trimethylolpropane diacrylate, 1,6-hexane diol diacrylate, neopentyl glycol diacrylate, diethylene glycol diacrylate, dipropylene glycol diacrylate, triethylene glycol diacrylate, tripropylene glycol diacrylate, and any mixture thereof. If appropriate, they may further comprise (additional) alkoxy groups, preferably propoxy groups, whereby the maximum number of alkoxy groups is such that the molar mass remains lower than 750 g/mol. More preferred examples of said one or more acrylate diluents (B) with an acrylate functionalilty of 2 are dipropyleneglycol diacrylate (DPGDA) (with the corresponding molecular formula C₁₂H₁₈O₅ and its corresponding molar mass of 242 g/mol); dipropyleneglycol diacrylate comprising additional alkoxy groups, preferably propoxy groups; and any mixture thereof.

Preferred examples of said one or more acrylate diluents (B) with an acrylate functionalilty of 3 are trimethylolpropane triacrylate, di(trimethylolpropane) triacrylate, pentaerythritol triacrylate, glyceryl propoxy triacrylate, and any mixture thereof. If appropriate, they may further comprise (additional) alkoxy groups, preferably propoxy groups, whereby the maximum number of alkoxy groups is such that the molar mass remains lower than 750 g/mol. More preferred examples of said one or more acrylate diluents (B) with an acrylate functionalilty of 3 are di(trimethylolpropane) tri-acrylate (di-TMP3A) with the corresponding molecular formula C₂₁H₃₂O₈ and its corresponding molar mass of 412 g/mol; di(trimethylolpropane) tri-acrylate comprising alkoxy groups, preferably propoxy groups; glyceryl propoxy triacrylate (GPTA) with the corresponding molecular formula C₂₁H₃₂O₉ and its corresponding molar mass of 428 g/mol; glyceryl propoxy triacrylate comprising additional alkoxy groups, preferably propoxy groups; pentaerythritol tri-acrylate (PET3A) with the corresponding molecular formula C₁₄H₁₈O₇ and its corresponding molar mass of 298 g/mol; pentaerythritol tri-acrylate comprising alkoxy groups, preferably propoxy groups; trimethylolpropane triacrylate (TMPTA) with the corresponding molecular formula C₁₅H₂₀O₆ and its corresponding molar mass of 296 g/mol; trimethylolpropane triacrylate comprising alkoxy groups, preferably propoxy groups; and any mixture thereof.

The radiation-curable diluents (B) with an acrylate functionality of 2 or 3 preferably comprises alkoxy groups, preferably propoxy groups (—C₃H₆O—). In case radiation-curable diluent (B) comprises (additional) alkoxy groups, the maximum number of alkoxy groups is such that the molar mass remains lower than 750 g/mol.

In a preferred embodiment of the invention, at least 10 wt. %, preferably at least 20 wt. %, more preferably at least 30 wt. % more preferably at least 40 wt. %, more preferably at least 50 wt. %, more preferably at least 60 wt. %, more preferably at least 70 wt. %, more preferably at least 80 wt. %, more preferably at least 90 wt. % and most preferably 100 wt. % of the radiation-curable diluents (B) is selected from the group consisting of:
di(trimethylolpropane) tri-acrylate (di-TMP3A) with the corresponding molecular formula C₂₁H₃₂O₈ and its corresponding molar mass of 412 g/mol, di(trimethylolpropane) tri-acrylate comprising alkoxy groups,
glyceryl propoxy triacrylate (GPTA) with the corresponding molecular formula C₂₁H₃₂O₉ and its corresponding molar mass of 428 g/mol,
glyceryl propoxy triacrylate comprising additional alkoxy groups,
pentaerythritol tri-acrylate (PET3A) with the corresponding molecular formula C₁₄H₁₈O₇ and its corresponding molar mass of 298 g/mol,
pentaerythritol tri-acrylate comprising alkoxy groups,
trimethylolpropane triacrylate (TMPTA) with the corresponding molecular formula C₁₅H₂₀O₆ and its corresponding molar mass of 296 g/mol,
trimethylolpropane triacrylate comprising alkoxy groups,
dipropyleneglycol diacrylate (DPGDA) with the corresponding molecular formula C₁₂H₁₈O₅ and its corresponding molar mass of 242 g/mol,
dipropyleneglycol diacrylate comprising additional alkoxy groups,
and any mixture thereof.

Preferably, the acrylate functionality of the at least one radiation-curable diluent (B) is 2.

The radiation-curable coating composition used in the process of the present invention may also comprise acrylate diluents with a molar mass as defined for the (B) compounds present in the radiation-curable coating composition (i.e. lower than 750 g/mol, preferably of at most 650 g/mol, more preferably of at most 500 g/mol, more preferably of at most 450 g/mol and preferably of at least 125 g/mol, more preferably of at least 150 g/mol, more preferably of at least 175 g/mol, even more preferably of at least 200 g/mol) but with a different acrylate functionality than defined for (B), for example with an acrylate functionality of 1, 4, or 5. Such acrylate diluents are preferably present in the radiation-curable coating composition in such an amount that the average acrylate functionality of the acrylate diluents with a molar mass as defined for (B) is in the range of preferably from 1.8 to 3.2. As used herein, the average acrylate functionality of the acrylate diluents with a molar mass as defined for

$$( B ) = \overline{f} = \frac{{\sum }_{k} \frac{{w}_{k}}{{M}_{k}} {f}_{k}}{{\sum }_{k} \frac{{w}_{k}}{{M}_{k}}} ,$$

in which wₖ is the amount of acrylate diluents in g present in the radiation curable coating composition with a molar mass Mₖ as defined for (B) and with an acrylate functionality fₖ which can be as defined for (B) or lower or higher than as defined for (B). We illustrate the average acrylate functionality calculation with a theoretical example: For a formulation consisting of 60 grams of vinyl polymer, 30 grams of DPGDA (having molar mass 242 g/mol and acrylate functionality of 2), 10 grams of Di-TMPTA (having molar mass 466 g/mol and acrylate functionality of 4), and 2.5 grams of photoinitiator: the summation over components k includes only DPGDA and Di-TMPTA and the calculated average functionality of acrylate diluents of this theoretical formulation is

$$\overline{f} = \frac{\frac{30 g}{242 \frac{g}{mol}} \times 2 + \frac{10 g}{466 \frac{g}{mol}} \times 4}{\frac{30 g}{242 \frac{g}{mol}} + \frac{10 g}{466 \frac{g}{mol}}} = 2.3 .$$

Preferably, the radiation-curable coating composition used in the process of the present comprises monofunctional diluent in an amount less than 7 wt. %, more preferably at less than 5 wt. %, more preferably less than 3 wt. %, more preferably less than 1 wt. %, most preferably less than 0.5 wt. %, relative to the weight of the entire radiation-curable coating composition.

The amounts of (A) and (B) in the aqueous, radiation-curable coating composition can vary within wide ranges as water and optional organic solvent can be used to adopt the viscosity and to tune the layer thickness of the applied coating. Preferably, the amount of (A) is from 35 to 75 wt. % and the amount of (B) is from 25 to 65 wt. %, preferably the amount of (A) is from 35 to 70 wt. % and the amount of (B) is from 30 to 65 wt. %, more preferably the amount of (A) is from 35 to 65 wt. % and the amount of (B) is from 35 to 65 wt. %, more preferably the amount of (A) is from 40 to 65 wt. % and the amount of (B) is from 35 to 60 wt. %, most preferably the amount of (A) is from 40 to 60 wt. % and the amount of (B) is from 40 to 60 wt. % based on the total amount of (A) and (B).

The summed amount of (A) and (B) is preferably from 10 to 60 wt. %, more preferably from 15 to 50 wt. %, more preferably from 15 to 45 wt. %, even more preferably from 20 to 40 wt. %, even more preferably from 25 to 35 wt. %, based on the entire weight of the aqueous, radiation-curable coating composition.

The amount of water in the aqueous, radiation-curable coating composition is preferably at least 30 wt. %, or at least 35 wt. %, or at least 40 wt. %, or at least 45 wt. %, or at least 50 wt. %, or at least 55 wt. %, or at least 60 wt. %, or at least 70 wt. %, based on the entire weight of the aqueous, radiation-curable coating composition.

The optional organic solvent is present in the aqueous, radiation-curable coating composition in an amount of at most 30 wt. %, preferably at most 25 wt. %, more preferably at most 20 wt. %, more preferably in an amount of at most 15 wt. %, more preferably in an amount of at most 10 wt. %, more preferably in an amount of at most 5 wt. %, more preferably in an amount of at most 4 wt. %, more preferably in an amount of at most 3 wt. %, more preferably in an amount of at most 2 wt. %, more preferably in an amount of at most 1 wt. %, wherein the amount of organic solvent is given based on the total amount of water and organic solvent present in the aqueous, radiation-curable coating composition. Suitable organic solvents are solvents which are inert in respect of the functional groups present in the coating composition. Suitable solvents are for example hydrocarbons, alcohols, ketones and esters, such as co-solvents also having the function of coalescent such as 1-methyl-2-pyrrolidinone, glycols and glycol ethers such as butyldiglycol, dipropylene glycol methyl ether, acetone, methyl ethyl ketone and alkyl ethers of glycol acetates or mixtures thereof. and ester alcohol like 2,2,4-trimethyl-1,3-pentanediol monoisobutyrate (Texanol). Most preferably the aqueous, radiation-curable coating composition is essentially free of organic solvent, i.e. organic solvent is preferably not deliberately be added (i.e. small amounts of organic solvent may be present in the additives used to prepare the composition) to the aqueous, radiation-curable coating composition.

The viscosity of the dispersion consisting of (A), (B) and (C) and containing from 10 to 60 wt. % of (A) and (B), relative to the total amount of (A), (B) and (C), is preferably from 10 to 1000 mPa·s, or from 10 to 800 mPa·s, or from 10 to 500 mPa·s. The viscosity is determined as further described herein.

The z-average particle size of the dispersion consisting of (A), (B) and (C) is preferably from 20 to 1000 nm, more preferably from 25 to 500 nm, even more preferably from 25 to 250 nm and most preferably from 30 to 200 nm, whereby the z-average particle size is determined as further described herein.

The coating composition usually further contains an additive compound; that is, a collection of one or more than one individual additives having one or more than one specified structure or type. Suitable additives are for example light stabilizers, such as UV absorbers and reversible free-radical scavengers (HALS), photosensitizers, antioxidants, degassing agents, wetting agents, emulsifiers, slip additives, waxes, polymerization inhibitors, adhesion promoters, flow control agents, film-forming agents, rheological aids such as thickeners, flame retardants, corrosion inhibitors, waxes, driers and biocides. One or more of the aforementioned additives can be employed in the coating composition used in the process of the present invention in any suitable amount and may be chosen singly or in combination of one or more of the types enumerated herein. In a preferred embodiment, the additive compound is present in an amount, relative to the entire weight of the radiation-curable coating composition, of from about 0 wt. % to 40 wt. %, or from 0 wt. % to 30 wt. %, or from 0 wt. % to 20 wt. %, or from 0 wt. % to 10 wt. %, or from 0 wt. % to 5 wt. %; or from 0.01 wt. % to 40 wt. %; or from 0.01 wt. % to 30 wt. %, or from 0.01 wt. % to 20 wt. %, or from 0.01 wt. % to 10 wt. %, or from 0.01 wt. % to 5 wt. %, or from 0.1 wt. % to 2 wt. %. An additional advantage of the present invention is that the coating composition can also be pigmented, while this does not significantly complicate the application of the coating composition on the substrate. The coating composition then contains at least one pigment. In the art titanium dioxide (TiO₂) is considered as a commercially important white pigment. Despite the porous nature of this type of pigment, it has furthermore surprisingly been found that the presence of such type of pigments in the coating composition as defined herein, hardly impair the coffee, red wine and/or mustard resistance of the coating or only deteriorates to such an extent that the resistance to coffee, red wine and/or mustard remains at an acceptable level. The coating composition can also contain one or more inorganic fillers. The coating composition can also contain external matting agents which have an additional matting effect, although this is not preferred. Suitable external matting agents are for example inorganic silica or organic waxes. The maximum amount of external matting agents is preferably at most 1.5 wt. %, more preferably at most 1 wt. % and most preferably at most 0.5 wt. %, relative to the entire weight of the coating composition.

The process of the invention optionally comprises a pre-curing step (2a). Performing the pre-curing step (2a) may be advantageous for improving adhesion, in particular for improving intercoat adhesion. In this optional step (2a) pre-curing of the at least partially dried coating composition is effected, affording an at least partially cured coating composition. In optional step (2a) some of the reactive ethylenically unsaturated double bonds of the curable compounds polymerize in the uncured coating layer, so that the coating layer partially cures but is not yet fully cured. This process is also known as pre-curing.

Accordingly, the process of the invention comprises the steps in the sequence (1), (2), (2a), (3) and (4):
(1) Applying an aqueous, radiation-curable coating composition on a surface of a substrate,
(2) Drying the aqueous, radiation-curable coating composition, affording an at least partially dried coating composition,
(2a) Optionally pre-curing the at least partially dried coating composition by irradiating the at least partially dried coating composition with UV light having a wavelength of from 300 to 450 nm, preferably from 300 to 420 nm with a radiation dose which results in partial curing of the layer, preferably with a radiation dose from 20 to 200 mJ/cm², more preferably with a radiation dose from 30 to 100 mJ/cm², affording an at least partially cured coating composition,
(3) Irradiating the at least partially dried coating composition or the at least partially cured coating composition with UV light having a wavelength s 220 nm preferably with a wavelength 120 nm, more preferably >150 nm, particularly preferably 172 nm or 195 nm, under inert atmosphere, followed by
(4) Irradiating with UV light having a wavelength 300 nm or with E-beam.

In step (1) of the process of the invention, the aqueous, radiation-curable coating composition is applied to a substrate by methods known to the person skilled in the art, such as for example knife coating, brushing, roller coating, spraying. The coating composition is applied to the substrate in a coating thickness (before drying) of preferably from 5 to 300 micron, more preferably from 15 to 175 micron, more preferably from 20 to 150 micron, more preferably from 25 to 125 micron.

In step (2) of the process of the invention, drying of the aqueous, radiation-curable coating composition that is applied to the substrate is preferably effected at a temperature higher than 30° C. to evaporate water and optionally organic solvent and other volatile compounds, affording an at least partially dried coating composition. The term “drying” refers to the loss of water and, if present, organic solvent and other volatile compounds such as for example neutralizing amines, from the aqueous coating composition by evaporation to such extend that preferably at least 80 wt. % of the water is removed.

The irradiating in the optional pre-curing step (2a) preferably takes place under atmospheric conditions, in other words not under inert gas conditions and/or not in an oxygen-reduced atmosphere. UV-A-emitting radiation sources (e.g. fluorescent tubes, LED lamps), high- or medium-pressure mercury vapour lamps, wherein the mercury vapour can be modified by doping with other elements such as gallium or iron, pulsed lamps (known as UV flash lamps) or halogen lamps are suitable as radiation sources for UV light in the specified wavelength range in step (2a). In a preferred embodiment of the invention, the process is performed without step (2a), i.e., the curing of the radiation-curable coating composition is effected in only 2 irradiation steps (i.e. step (3) and (4)).

Suitable radiation sources for step (3) are excimer UV lamps, which emit UV light with a wavelength s 220 nm and preferably with a wavelength 120 nm, more preferably 150 nm, particularly preferably 172 nm or 195 nm. The radiation dose used in step (3) is usually in the range from 0.1 to 150 mJ/cm², preferably in the range of from 1 to 100 mJ/cm², more preferably from 1 to 20 mJ/cm², more preferably from 2 to 15 mJ/cm². Step (3) must be performed in an inert gas atmosphere. An inert gas atmosphere is understood to mean an essentially oxygen-free atmosphere, i.e. an atmosphere which contains less than 0.5 percent by volume of oxygen, preferably less than 0.1 percent by volume of oxygen and especially preferably less than 0.05 percent by volume of oxygen. As a rule, an inert gas atmosphere is achieved by flushing the area which is exposed to the UV radiation with a stream of inert gas. The inert gas atmosphere prevents undesired ozone formation on the one hand and prevents the polymerization of the lacquer layer from being inhibited on the other hand.

Examples of inert gases are nitrogen, helium, neon or argon. Nitrogen is particularly preferably used. This nitrogen should only contain very small amounts of foreign gases such as oxygen, preferably with a purity grade of <300 ppm oxygen.

In step (4) of the process of the present invention, the coating layer obtained in step (3) is irradiated with UV light having a wavelength (higher than or equal to) 300 nm or with E-beam to achieve that the radiation-curable compounds of the coating composition largely or preferably completely polymerizes, so that the coating layer is preferably fully cured. In case E-beam irradiation (150 to 300 kV) is applied in step (4), usually a dose of 10 to 100 kGy, preferably 20 to 50 kGy, is applied. In step (4) UV irradiation is preferred, preferably with a wavelength of from 300 to 420 nm and preferably with a radiation dose of from 100 to 2000 mJ/cm², more preferably from 150 to 1500 mJ/cm². High- and medium-pressure mercury vapour lamps can in particular be used as UV radiation sources, wherein the mercury vapour can be doped with further elements such as gallium or iron. Step (4) can optionally also be performed in an inert gas atmosphere. In case UV irradiation is applied in step (4), the radiation-curable coating composition comprises a photo-initiator. If the radiation curable coating composition of the invention comprise one or more photo-initiators, they are included in an amount sufficient to obtain the desired cure response. Typically, the one or more photo-initiators are included in amounts in a range of from 0.1 to 5% by weight of the entire coating composition. Preferably, the one or more photo-initiators are present in an amount, relative to the entire weight of the coating composition, of from 0.25 wt. % to 4 wt. %, more preferably from 0.5 wt. % to 3.5 wt. % and even more preferably from 0.5 wt. % to 3 wt. %. A photoinitiator is a compound that chemically changes due to the action of light or the synergy between the action of light and the electronic excitation of a sensitizing dye to produce at least one of a radical, an acid, and a base. Well-known types of photoinitiators include cationic photoinitiators and free-radical photoinitiators. According to an embodiment of the present invention, the photoinitiator is a free-radical photoinitiator. In an embodiment, the photoinitiator compound includes, consists of, or consists essentially of one or more acylphosphine oxide photoinitiators. Acylphosphine oxide photoinitiators are known, and are disclosed in, for example, U.S. Pat. Nos. 4,324,744, 4,737,593, 5,942,290, 5,534,559, 6,020,529, 6,486,228, and 6,486,226. Preferred types of acylphosphine oxide photoinitiators for use in the photoinitiator compound include bisacylphosphine oxides (BAPO) or monoacylphosphine oxides (MAPO). More specifically, examples include 2,4,6-trimethylbenzoylethoxyphenylphosphine oxide (CAS #84434-11-7) or 2,4,6-trimethylbenzoyldiphenylphosphine oxide (CAS #127090-72-6).

In a preferred embodiment, the photoinitiator compound may also optionally comprise, consist of, or consist essentially of α-hydroxy ketone photoinitiators. For instance, suitable α-hydroxy ketone photoinitiators are α-hydroxycyclohexyl phenyl ketone, 2-hydroxy-2-methyl-1-phenylpropanone, 2-hydroxy-2-methyl-1-(4-isopropylphenyl)propanone, 2-hydroxy-2-methyl-1-(4-dodecylphenyl)propanone, 2-Hydroxy-1-{4-[4-(2-hydroxy-2-methyl-propionyl)-benzyl]-phenyl}-2-methyl-propan-1-one and 2-hydroxy-2-methyl-1-[(2-hydroxyethoxy)phenyl]propanone.

In another embodiment, the photoinitiator compound includes, consists of, or consists essentially of: α-aminoketones, such as 2-methyl-1-[4-(methylthio)phenyl]-2-(4-morpholinyl)-1-propanone, 2-benzyl-2-(dimethylamino)-1-[4-(4-morpholinyl)phenyl]-1-butanone, 2-(4-methylbenzyl-2-(dimethylamino)-1-[4-(4-morpholinyl)phenyl]-1-butanone or 2-benzyl-2-(dimethylamino)-1-[3,4-dimethoxyphenyl]-1-butanone; benzophenones, such as benzophenone, 2,4,6-trimethylbenzophenone, 4-methylbenzophenone, 2-methylbenzophenone, 2-methoxycarbonylbenzophenone, 4,4′-bis(chloromethyl)-benzophenone, 4-chlorobenzophenone, 4-phenylbenzophenone, 4,4′-bis(dimethylamino)-benzophenone, 4,4′-bis(diethylamino)benzophenone, methyl2-benzoylbenzoate, 3,3′-dimethyl-4-methoxybenzophenone, 4-(4-methylphenylthio)benzophenone, 2,4,6-trimethyl-4′-phenyl-benzophenone or 3-methyl-4′-phenyl-benzophenone; ketal compounds, for example 2,2-dimethoxy-1,2-diphenyl-ethanone; and monomeric or dimeric phenylglyoxylic acid esters, such as methylphenylglyoxylic acid ester, 5,5′-oxo-di(ethyleneoxydicarbonylphenyl) or 1,2-(benzoylcarboxy)ethane.

Yet further suitable photoinitiators for use in the photoinitiator compound include oxime esters, such as those disclosed in U.S. Pat. No. 6,596,445. Still another class of suitable photoinitiators for use in the photoinitiator compound include, for example, phenyl glyoxalates, for example those disclosed in U.S. Pat. No. 6,048,660.

In another embodiment, the photoinitiator compound may comprise, consist of, or consist essentially of one or more alkyl-, aryl-, or acyl-substituted compounds not mentioned above herein.

According to another embodiment, the composition may contain a photoinitiator that is an alkyl-, aryl-, or acyl-substituted compound. In an embodiment the alkyl-, aryl-, or acyl-substituted photoinitiator possesses or is centered around an atom in the Carbon (Group 14) group. In such instance, upon excitation (via absorption of radiation) the Group 14 atom present in the photoinitiator compound forms a radical. Such compound may therefore produce a radical possessing or centered upon an atom selected from the group consisting of silicon, germanium, tin, and lead. In an embodiment, the alkyl-, aryl-, or acyl-substituted photoinitiator is an acylgermanium compound. Such photoinitiators are described in, U.S. Pat. No. 9,708,442. Known specific acylgermanium photoinitiators include benzoyl trimethyl germane (BTG), tetracylgermanium, or bis acyl germanoyl (commercially available as Ivocerin® from Ivoclar Vivadent AG, 9494 Schaan/Liechtenstein).

Photoinitiators may be employed singularly or in combination of one or more as a blend.

Suitable photoinitiator blends are for example disclosed in U.S. Pat. No. 6,020,528_and U.S. Pat. App. No. 60/498,848. According to an embodiment, the photoinitiator compound includes a photoinitiator blend of, for example, bis(2,4,6-trimethylbenzoyl) phenyl phosphine oxide (CAS #162881-26-7) and 2,4,6,-trimethylbenzoylethoxyphenylphosphine oxide (CAS #84434-11-7) in ratios by weight of about 1:11, 1:10, 1:9, 1:8 or 1:7.

Another especially suitable photoinitiator blend is a mixture of bis(2,4,6-trimethylbenzoyl)phenyl phosphine oxide, 2,4,6,-trimethylbenzoylethoxyphenylphosphine oxide and 2-hydroxy-2-methyl-1-phenyl-1-propanone (CAS #7473-98-5) in weight ratios of for instance about 3:1:15 or 3:1:16 or 4:1:15 or 4:1:16. Another suitable photoinitiator blend is a mixture of bis(2,4,6-trimethylbenzoyl)phenyl phosphine oxide and 2-hydroxy-2-methyl-1-phenyl-1-propanone in weight ratios of for instance about 1:3, 1:4 or 1:5.

One or more of the aforementioned photoinitiators can be employed for use in the photoinitiator compound in compositions according to the present invention in any suitable amount and may be chosen singly or in combination of one or more of the types enumerated herein. In a preferred embodiment, the photoinitiator compound comprises, consists of, or consists essentially of free-radical photoinitiators, preferably of the α-cleavage type.

Suitable substrates for the process according to the invention are for example mineral substrates such as fiber cement board, wood, wood containing materials, paper including cardboard, textile, leather, metal, thermoplastic polymer, thermosets, ceramic, glass.

Suitable thermoplastic polymers are for example polyvinylchloride PVC, polymethylmethacrylate PMMA, acrylonitrile-butadiene-styrene ABS, polycarbonate, polypropylene PP, polyethylene PE, polyamide PA, polyethylene terephthalate PET and polystyrene PS. Suitable thermosets are for example linoleum, epoxy, melamine, novolac, polyesters and urea-formaldehyde.

The substrate is optionally pre-treated and/or optionally pre-coated. For example, thermoplastic plastic films can be treated with corona discharges before application or pre-coated with a primer. Mineral building materials are also usually provided with a primer before the coating composition is applied.

The coating obtained in the process of the invention can advantageously be used in a floor or wall covering or in automotive interior or on furniture.

With the process of the invention, low gloss coatings can advantageously be obtained with a dry thickness of at least 2 micron, or of at least 3 micron, or of at least 4 micron, and of at most 100 micron, or of at most 75 micron, or of at most 50 micron.

The present invention further relates to the aqueous, radiation-curable coating composition as described herein above. The present invention further relates to a coated substrate that is obtained by coating a substrate with the process as described herein above.

The present invention is now illustrated by reference to the following examples. Unless otherwise specified, all parts, percentages and ratios are on a weight basis.

### Method to Calculate the Dry Film Thickness

The dry film thickness is calculated by multiplying the wet film thickness times the solids content of the formulation used.

$$DFT = WFT * solids content / 100$$

Where
DFT: dry film thickness in μm
WFT: wet film thickness in μm
Solids content (wt. %): total weight of all solid compounds present in formulation divided by (total weight of the formulation*100).

### Measurement Methods

### Average Particle Size PS:

The intensity average particle size, z-average, has been determined by photon correlation spectroscopy using a Malvern Zetasizer Nano ZS. Samples are diluted in demineralized water to a concentration of approximately 0.1 g dispersion/liter. Measurement temperature 25° C. Angle of laser light incidence 173°. Laser wavelength 633 nm.

pH

The pH was measured using a Metrohm pH meter.

### Solids

The solid content of the dispersion was measured on a HB43-S halogen moisture analyzer from Mettler Toledo at a temperature of 130° C.

### Viscosity

The viscosity was determined using a Brookfield LV (spindle 2 at 60 rpm, room temperature)

### Gloss

The gloss is determined according to ISO2813 in the direction of the drawdown and is expressed in gloss units (GU).

### Stain Resistances

Stain resistances were tested according to IKEA IOS-MAT-066 R2 & RO.

### Nail Scratch Resistance

Use the tip of a fingernail to make a quick smooth stroke across the coating with increasing pressure. The scratch resistance is rated from 0 to 5 with 0=severe damage of the coating and 5=no mark visible.

### Differential Scanning Calorimetry (DSC)

Thermal characteristics of the samples were investigated under a nitrogen atmosphere using a DSC250 from TA Instruments. Indium was used for the enthalpy and temperature calibration of the instrument and an empty Tzero aluminum pan was used as the reference. The thermal transitions of the samples were investigated with the temperature program described in the Table below. The first heating curve were used to extract the Tg data. In case the polymer system comprises two or more phases with different Tg, the phase ratios are calculated by calculating the heat capacity (Cp) from the heat flow curves for each Tg transition, adding them up and then calculating the relevant amounts of the different phases. For example, when the polymer system has two phases with different Tg, the amounts are calculated as Cp1/(Cp1+Cp2)*100% and Cp2/(Cp1+Cp2)*100%.

### DSC Temperature Program

| Start temperature | End temperature | Temperature ramp | Isothermal |
|---|---|---|---|
| (° C.) | (° C.) | (° C./min) | period (min) |
| 40 | −85 | 20 | 10 |
| −85 | 180 | 10 | 5 |
| 180 | −85 | 20 | 10 |
| −85 | 180 | 10 | — |

The DSC samples were dried overnight at 120° C. under air. Approximately 5 mg sample was sealed in a Tzero aluminum pan.

Determination of Number Average Molecular Weight, Weight Average Molecular Weight, z-Average Molecular Weight and Molecular Weight Distribution

The number average molecular weight, weight average molecular weight, z-average molecular weight and molecular weight distribution was determined with Size exclusion chromatography in THF HAC 0.8% with two PLgel 10 μm Mixed-C columns at 40° C. on a Waters Alliance 2695 LC system with a Waters 2410 DRI detector. Tetrahydrofuran with 0.8% v/v Acetic acid 100% (THF HAC 0.8%) was used as eluent with a flow of 1 mL/min. The samples are dissolved in the eluent using a concentration of 5 mg polymer per mL solvent. The solubility is judged with a laser pen after 24 hours stabilization at room temperature; if any scattering is visible the samples are filtered first and 150 μl sample solution is injected (0.45 micron PTFE filter). The M_{w} (weight average molecular weight), Mz (z-average molecular weight) and MwD (molecular weight distribution) results are calculated with narrow polystyrene standards from 162 to 1.730.000 Da.

### Components and Abbreviations Used:

DPGDA=Agisyn™ 2833, dipropyleneglycoldiacrylate, available from Covestro
GPTA=Agisyn™ 2837, propoxylated(3)glycerol triacrylate, available from Covestro
TMPTA=trimethylolpropane triacrylate, available from Covestro
DPHA=Agisyn™ 2830L, dipentaerythritolhexaacrylate, available from Covestro
Omnirad 500=photoinitiator available from IGM
BYK 346=Surfactant available from BYK (45% solids)
TEGO@Airex 902W=defoamer available from Evonik (24% solids)
Borchi@Gel L 75 N=Rheology modifier available from Borchers (50% solids)
Acematt@TS 100=silica matting agent from Evonik
MEK=methylethylketone available from Aldrich
MMA=methyl methacrylate available from Aldrich
n-BA=n-butyl acrylate available from Aldrich
MAA=methacrylic acid available from Aldrich
AA=acrylic acid available from Aldrich
S=styrene available from Aldrich
2-EHA-=2-ethylhexyl acrylate available from Aldrich
AMBN=2,2′-azobis(2-methylpropionitrile) available from Aldrich
SLS=sodium lauryl sulphate available from Aldrich
AP=ammonium persulphate available from Aldrich
KOH=potassium hydroxide available from Aldrich
n-DM=n-dodecyl mercaptane available from Bruno Bock GMBH

### Description of the Commercial Binders Used

Neocryl XK-82 is a high molecular weight, medium Tg, single phase styrene-acrylic binder available from Covestro. The measured Tg (DSC) is 49° C. Acid value: 50.1 mg KOH/g solids. The solid content is 40 wt %.

Neocryl XK-85 is a low molecular weight, medium Tg, single phase styrene-acrylic binder available from Covestro. The measured Tg (DSC) is 31° C. Acid value: 45.5 mg KOH/g solids. The solid content is 40 wt %.

Neocryl XK-110 is a multiphase OH functional acrylic binder with controlled molecular weight prepared via gradient polymerization and theoretically two Tg's. The measured Tg (DSC) is 49° C. Acid value: 15.6 mg KOH/g solids. The solid content is 46.5 wt %.

Neocryl XK-14 is a multiphase styrene-acrylic binder with a high and low molecular weight phase and low and high Tg polymer phases. Acid value: 13.7 mg KOH/g solids. The solid content is 40 wt %.

Neocryl XK-102 is a OH functional acrylic binder. Acid value 31.2 mg KOH/g solid. The solid content is 40 wt %.

TABLE 1
Specifications of the commercial binders used.

| Binder | XK-82 | XK-85 | XK-110 | XK-14 | XK-102 |
|---|---|---|---|---|---|
| Solid content (wt %) | 40 | 40 | 46.5 | 40 | 40 |
| Measured T_{g} | 49 | 31 | 44 | 32.6/121.6 * | 54.4 |
| (DSC, ° C.) | | | | | |
| Acid value (mg | 50.1 | 45.5 | 15.6 | 14.6 | 31.2 |
| KOH/g solid) | | | | | |

* The amount of vinyl polymer with T_{g} of 32.6° C. in XK-14 is higher than 50 wt. %.

### Preparation of the Solution Acrylic Polymers SA1

A 2 L kettle equipped with heating and colling control was charged with methylethyl ketone (MEK, 318.9 gram) and heated to 80° C. In a feedtank a solution of methyl methacrylate (MMA, 558.6 gram), n-butyl acrylate (n-BA, 413.8 gram), methacrylic acid (MAA, 62.1 gram) and 2,2′-azobis(2-methylpropionitrile) (AMBN, 10.4 gram) was prepared. At 80° C. the monomer feed was added in 180 minutes. After completion of the monomer feed the feed tank was rinsed with methylethyl ketone, (MEK, 31.0 gram) and the reaction mixture was kept at 80° C. for 60 minutes. Next, 2,2′-azobis(2-methylpropionitrile) (AMBN, 5.2 gram) was added and the reaction mixture was kept at 80° C. for an additional 60 minutes. Finally was MEK added to end up with a solid content of 54.0 wt %. The weight average molecular weight was 98.4 kDa, the number average molecular weight was 12.1 kDa. The Tg as calculated according to Flory-Fox is 22° C. and the acid value is 39.3 mg KOH/g solid.

Dispersion of the solution acrylic SA1 containing no reactive diluent (DSA1) In a 1 L kettle equipped with heating and colling control the acrylic solution polymer (259.3 gram, 54% solids) was heated under stirring to 40° C. Next, triethylamine (4.9 gram) was added in 5 minutes followed by demineralised water (294.9 gram) in 10 minutes. After mixing for 10 minutes vacuum was applied and the methylethylketone and water was removed until a final solid content of 30.2 wt % was reached.

Dispersions of the solution acrylic SA1 containing reactive diluent (DSA2-DSA3) For the dispersion of the solution acrylic with reactive diluent DSA2-DSA3, the same method was applied as for preparing DSA1, except that the reactive diluent (DPDGA) was added prior to heating to 40° C. The applied amounts of triethylamine and demineralised water are reported in Table 2.

TABLE 2
Compositions and specifications of DSA1 to DSA3.

| | DSA1 | DSA2 | DSA3 |
|---|---|---|---|
| Solution polymer | 259.3 | 207.4 | 155.6 |
| (54% solids) (A) (g) | | | |
| Agisyn 2833 (B) (g) | 0.0 | 28.0 | 56.0 |
| Amount (A) | 100 | 80 | 60 |
| relative to (A) + (B) | | | |
| Amount (B) | 0 | 20 | 40 |
| relative to (A) + (B) | | | |
| Triethylamine | 4.9 | 4.9 | 4.1 |
| Demineralised | 294.9 | 287.0 | 279.8 |
| water | | | |

Final specifications

| | | | |
|---|---|---|---|
| pH | 8.7 | 8.6 | 8.6 |
| Viscosity (20° C.) | 52 | 16 | 12 |
| Solid content (%) | 30.2 | 27.4 | 31.0 |

### Preparation of the Emulsion Polymer EP1

A 2000 cm³ flask equipped with a thermometer, N₂ inlet and overhead stirrer was charged with demineralised water (656.8 g) and sodium lauryl sulphate (19.3 g of a 30 wt % solution in water). In a funnel an emulsified monomer feed was prepared by mixing demineralised water (278.1 g), sodium lauryl sulphate (28.89 g of a 30 wt % solution in water), styrene (5, 334.3 g), 2-ethylhexyl acrylate (2-EHA, 333.0 g), methacrylic acid (MAA, 20.64 g) and n-dodecyl mercaptane (13.8 g). In another funnel an initiator solution was charged by dissolving ammonium persulphate (AP, 2.3 g) in demineralised water (68.6 g) and adjusting the pH with 25% ammonia to 7.0-7.5. The reactor was heated to 65° C. and 10 wt % of the emulsified monomer feed was added to the reactor and the reaction temperature was allowed to increase to 75° C. At 75° C. a shot of ammonium persulphate (1.2 g) dissolved in demineralized water (6.0 g) was added and the exotherm was allowed to run. After mixing for 10 minutes the reactor temperature was levelled at 85° C. Next, the monomer feed and initiator feed were added over a period of 150 minutes at a temperature of 83-87° C. At the end of the monomer feed demineralised water (7.4 g) was used to rinse the funnel holding the monomer mixture. The reaction was allowed to drift for 15 minutes to 80° C. Next, a solution of ammonia (25%, 4.5 g) in demineralised water (4.5 g) was added and the temperature was allowed to drift for 15 minutes. Next the batch was cooled to 30° C. and Proxel Ultra 10 (3.6 g of a 10 wt % solution) was added in 10 minutes. The pH was checked and if needed adjusted to 7.8-8.0 with ammonia (12.5%). Finally, the batch was filtered through a filter cloth to remove any coagulum formed during the reaction. The solid content was 39.4%, the particle size was 72 nm. The theoretical Tg was set at 10° C., the measured Tg (DSC) was 1.9° C. The acid value was 19.5 mg KOH/g solid.

All other binders reported in Table 3 were prepared according the procedure described above for binder EP1 using the amounts listed in Table 3. Binders EP13 and EP14 were neutralized with KOH instead of ammonia.

TABLE 3
Compositions and specifications of binders EP2 to EP14.

| | EP2 | EP3 | EP4 | EP5 | EP6 | EP7 | EP8 |
|---|---|---|---|---|---|---|---|
| S | | 286.5 | | 543.9 | | 509.0 | |
| 2-EHA | | 346.4 | | 123.4 | | 123.9 | |
| MMA | 342.1 | | 296.4 | | 539.2 | | 504.8 |
| n-BA | 325.2 | | 336.5 | | 128.1 | | 128.1 |
| MAA | 20.6 | 55.0 | 55.0 | | | | |
| AA | | | | 20.6 | 20.6 | 55.0 | 55.0 |
| n-DM | 13.8 | 13.8 | 13.8 | 13.8 | 13.8 | 13.8 | 13.8 |
| Solids (%) | 39.6 | 38.9 | 39.4 | 39.4 | 39.6 | 38.9 | 38.9 |
| Acid value (mg | 19.5 | 52.0 | 52.0 | 23.4 | 23.4 | 62.4 | 62.4 |
| KOH/g solid) | | | | | | | |
| Particle size (nm) | 83 | 64 | 73 | 70 | 74 | 75 | 108 |
| Tg (° C., th) | 10 | 10 | 10 | 60 | 60 | 60 | 60 |
| Tg (° C., DSC) | 10.2 | 2.6 | 18.7 | 55.5 | 65.1 | 61.5 | 67.6 |

| | EP9 | EP10 | EP11 | EP12 | EP13 | EP14 |
|---|---|---|---|---|---|---|
| S | 336.9 | | 492.8 | | 286.5 | |
| 2-EHA | 335.6 | | 145.0 | | 346.4 | |
| MMA | | 317.2 | | 543.4 | | 539.2 |
| n-BA | | 320.6 | | 129.1 | | 128.1 |
| MAA | 20.8 | | 55.5 | | 55.0 | |
| AA | | 55.5 | | 20.8 | | 20.6 |
| n-DM | 0.0 | 0.0 | 0.0 | 0.0 | 13.8 | 13.8 |
| Solids (%) | 40.3 | 38.6 | 39.0 | 39.2 | 38.0 | 38.4 |
| Acid value (mg | 19.5 | 62.4 | 52.0 | 23.4 | 52.0 | 23.4 |
| KOH/g solid) | | | | | | |
| pH | | | | | 7.23 | 7.20 |
| Particle size (nm) | 74 | | 75 | 80 | 69 | 99 |
| Tg (° C., th) | 10 | 10 | 60 | 60 | 10 | 60 |
| Tg (° C., DSC) | 11.8 | 24.5 | 75.8 | 77.3 | 1.8 | 67.4 |

TABLE 4
Formulations of the commercial binders.

| Formulation | F-XK-82 | F-XK-85a | F-XK-85b | F-XK-110a | F-XK-110b | F-XK-110c |
|---|---|---|---|---|---|---|
| Binder | XK-82 | XK-85 | XK-85 | XK-110 | XK-110 | XK-110 |
| Amount binder (g) | 68.42 | 68.00 | 68.00 | 66.00 | 66.60 | 66.60 |
| Reactive diluent | DPGDA | DPGDA | TMPTA | DPGDA | GPTA | DPHA |
| Amount reactive | 18.3 | 18.3 | 18.3 | 20.5 | 20.5 | 20.5 |
| diluent (g) | | | | | | |
| Amount (A) relative | 60 | 60 | 60 | 60 | 60 | 60 |
| to (A) + (B) | | | | | | |
| Amount (B) relative | 40 | 40 | 40 | 40 | 40 | 40 |
| to (A) + (B) | | | | | | |
| Demineralized water | 22.0 | 22.0 | 22.0 | 12.0 | 22.0 | 22.0 |
| Byk 346 | 0.5 | 0.5 | 0.5 | 0.5 | 0.5 | 0.5 |
| Tego Airex 902W | 0.5 | 0.5 | 0.5 | 0.5 | 0.5 | 0.5 |
| BorchiGel L75N:water | 1.76 | 2.63 | 2.63 | 1.44 | 1.0 | 1.0 |
| (1:1) | | | | | | |
| Omnirad 500 | 1.0 | 1.0 | 1.0 | 1.0 | 1.0 | 1.0 |
| Demineralized water | 5.81 | 5.71 | 5.71 | 18.56 | 8.4 | 8.4 |
| Solid content (%) | 28.1 | 28.3 | 28.3 | 28.1 | 27.9 | 27.9 |

| Formulation | F-XK-14a | F-XK-14b | F-XK-102 |
|---|---|---|---|
| Binder | XK-14 | XK-14 | XK-102 |
| Amount binder (g) | 67.40 | 66.00 | 66.00 |
| Reactive diluent | GPTA | DPGDA | DPGDA |
| Amount reactive | 18.0 | 40.5 | 40.5 |
| diluent (g) | | | |
| Amount (A) relative | 60 | 40 | 40 |
| to (A) + (B) | | | |
| Amount (B) relative | 40 | 60 | 60 |
| to (A) + (B) | | | |
| Demineralized water | 22.0 | 22.00 | 22.0 |
| Byk 346 | 0.5 | 0.5 | 0.5 |
| Tego Airex 902W | 0.5 | 0.5 | 0.5 |
| BorchiGel L75N:water | 0.95 | 1.2 | 1.10 |
| (1:1) | | | |
| Omnirad 500 | 1.0 | 1.0 | 1.0 |
| Demineralized water | 7.65 | 8.80 | 8.90 |
| Solid content (%) | 27.9 | 28.1 | 28.0 |

TABLE 5
Formulations of the dispersed solution acrylics DSA1 to DSA3.

| Formulation | F- DSA1 | F-DSA2 | F-DSA3 |
|---|---|---|---|
| Amount | 87.40 DSA1 | 95.81 DSA2 | 85.00 DSA3 |
| dispersion (g) | | | |
| Demineralized | 6.00 | 0.00 | 6.00 |
| water | | | |
| Byk 346 | 0.5 | 0.5 | 0.5 |
| Tego Airex | 0.5 | 0.5 | 0.5 |
| 902W | | | |
| BorchiGel | 1.08 | 1.00 | 1.02 |
| L75N:water | | | |
| (1:1) | | | |
| Omnirad 500 | 1.0 | 1.0 | 1.0 |
| Demineralized | 1.52 | 0.00 | 4.98 |
| water | | | |
| Total | 100 | 100 | 100 |
| Solids (%) | 28.0 | 27.8 | 27.9 |

### Formulations of the Emulsion Polymers EP1 to EP14

TABLE 6
Formulations of the emulsion polymer binders EP1 to EP14.

| Formulation | F-EP1 | F-EP2 | F-EP3 | F-EP4 | F-EP5 | F-EP6 | F-EP7 |
|---|---|---|---|---|---|---|---|
| Binder | EP1 | EP2 | EP3 | EP4 | EP5 | EP6 | EP7 |
| Amount binder | 66.5 | 66.5 | 66.5 | 66.5 | 66.5 | 66.5 | 66.5 |
| (g) | | | | | | | |
| Reactive diluent | DPDGA | DPGDA | DPDGA | DPGDA | DPDGA | DPGDA | DPGDA |
| Amount reactive | 17.5 | 17.6 | 17.2 | 17.5 | 17.5 | 17.6 | 17.2 |
| diluent (g) | | | | | | | |
| Amount (A) | 60 | 60 | 60 | 60 | 60 | 60 | 60 |
| relative to (A) + | | | | | | | |
| (B) | | | | | | | |
| Amount (B) | 40 | 40 | 40 | 40 | 40 | 40 | 40 |
| relative to (A) + | | | | | | | |
| (B) | | | | | | | |
| Demineralized | 20.0 | 20.0 | 20.0 | 20.0 | 20.0 | 20.0 | 20.0 |
| water | | | | | | | |
| Tego Airex | 0.5 | 0.4 | 0.4 | 0.4 | 0.4 | 0.4 | 0.4 |
| 902W | | | | | | | |
| Borchigel | 1.6 | 1.1 | 1.35 | 0.75 | 2.0 | 1.0 | 1.05 |
| L75N:water (1:1) | | | | | | | |
| Byk 349 | 0.3 | 0.4 | — | — | — | — | — |
| Omnirad 500 | 1.0 | 1.0 | 1.0 | 1.0 | 1.0 | 1.0 | 1.0 |
| Demineralized | 10.1 | 10.6 | 10.75 | 11.35 | 9.9 | 11.1 | 11.05 |
| water | | | | | | | |
| Solids (%) | 28.0 | 28.0 | 28.0 | 28.0 | 28.0 | 28.0 | 28.0 |
| Formulation | F-EP8 | F-EP9 | F-EP10 | F-EP11 | F-EP12 | F-EP13 | F-EP14 |
| Binder | EP8 | EP9 | EP10 | EP11 | EP12 | EP13 | EP14 |
| Amount binder | 66.5 | 66.5 | 66.5 | 66.5 | 66.5 | 66.5 | 66.5 |
| (g) | | | | | | | |
| Reactive diluent | DPDGA | DPGDA | DPDGA | DPGDA | DPDGA | DPGDA | DPGDA |
| Amount reactive | 17.2 | 17.9 | 17.1 | 17.3 | 17.4 | 16.8 | 17.0 |
| diluent (g) | | | | | | | |
| Amount (A) | 60 | 60 | 60 | 60 | 60 | 60 | 60 |
| relative to (A) + | | | | | | | |
| (B) | | | | | | | |
| Amount (B) | 40 | 40 | 40 | 40 | 40 | 40 | 40 |
| relative to (A) + | | | | | | | |
| (B) | | | | | | | |
| Demineralized | 20.0 | 20.0 | 20.0 | 20.0 | 20.0 | 20.0 | 20.0 |
| water | | | | | | | |
| Tego Airex | 0.4 | 0.4 | 0.5 | 0.4 | 0.4 | 0.4 | 0.4 |
| 902W | | | | | | | |
| Borchigel | 1.7 | 3.5 | 0.9 | 2.45 | 1.05 | 1.15 | 0.8 |
| L75N:water (1:1) | | | | | | | |
| Byk 349 | — | — | — | — | — | 0.3 | — |
| Omnirad 500 | 1.0 | 1.0 | 1.0 | 1.0 | 1.0 | 1.0 | 1.0 |
| Demineralized | 10.4 | 8.6 | 10.1 | 9.65 | 11.05 | 10.65 | 11.3 |
| water | | | | | | | |
| Solids (%) | 28.0 | 28.0 | 28.0 | 28.0 | 28.0 | 28.0 | 28.0 |

### Application of Formulations

The so-obtained coating compositions were applied on a Leneta card (2C Leneta Inc) using a 125 μm wire rod applicator. The coated cards were dried for 10 minutes in an oven with airspeed of 1.2 m/s at 50° C. Next the coatings were cured.

### Curing of the Dried Coating Composition

### Excimer/UV Cure:

Immediately (within 20 seconds) after drying the formulations were cured on a UVio curing rig with a conveyor belt speed of 15 m/min equipped with 2 lamps. The first Lamp was an Excirad 172 lamp (IOT GmbH, xenon based excimer lamp generating 172 nm light) under which the cure was performed with a radiation dose of 11.4 mJ/cm² (determined with an ExciTrack172, IOT GmbH) in a nitrogen atmosphere (O2 level<50 ppm detected with IOT inline detector). The next cure step was performed by the second lamp being a Light Hammer 10 Mark III equipped with a H-bulb operating @50% power (Heraeus Holding, Hg doped UV lamp generating UV light with wave lengths>315 nm, 181 mJ/cm² total dose as determined with an Power Puck II (EIT Inc)).

### Conventional UV Cure Atmospheric (Conv UV Cure):

Immediately (within 20 seconds) after drying the formulations were cured on a UVio curing rig with a conveyor belt speed of 15 m/min. The cure step was performed by a Light Hammer 10 Mark III equipped with a H-bulb operating @50% power (Heraeus Holding, Hg doped UV lamp generating UV light with wave lengths≥315 nm, 181 mJ/cm² total dose as determined with an Power Puck II (EIT Inc)) in air.

Gloss Values of the Commercial Binders after Excimer Cure and after Conventional UV Cure

TABLE 7
Gloss values of the formulations of the commercial binders
after Excimer cure and after conventional UV cure.

| Example | Ex1 | Ex2 | Ex3 | CEx1 | Ex4 | Ex5 |
|---|---|---|---|---|---|---|
| Formulation | F-XK-82 | F-XK-85a | F-XK-110a | F-XK-110c | F-XK-14b | F-XK-102 |
| Reactive | DPGDA | DPGDA | DPGDA | DPHA | DPGDA | DPGDA |
| diluent | | | | | | |
| Amount (s/s) | 40% | 40% | 40% | 40% | 60% | 60% |

Gloss (GU20°/60°/85°)

| | | | | | | |
|---|---|---|---|---|---|---|
| Excimer/UV | 0.3/3.5/27 | 0.2/2.2/14 | 0.3/4.0/13 | 53/89/93 | 0.1/0.8/12 | 0.1/0.9/4.9 |
| cure | | | | | | |
| Conv UV cure | 9/44/53 | 59/88/96 | 95/95/102 | 52/86/92 | 36/75/88 | 77/89/100 |

Table 7 shows that when DPHA is used as reactive diluent no low gloss coatings is obtained after excimer cure.

Gloss Values of the Formulations of the Dispersed Solution Acrylics DSA1 to DSA3 after Excimer Cure and after Conventional UV Cure

TABLE 8
Gloss values, the chemical resistances and nail scratch resistance
of the dispersed solution acrylics DSA1, DSA2 and DSA3 after
Excimer cure and after conventional UV cure.

| Example | CEx2 | CEx3 | Ex6 |
|---|---|---|---|
| Formulation | F-DSA1 | F-DSA2 | F-DSA3 |
| Reactive diluent | DPGDA | DPGDA | DPGDA |
| Amount (s/s) | 0% | 20% | 40% |

Gloss (GU20°/60°/85°)

| | | | |
|---|---|---|---|
| Excimer/UV cure | 62/85/98 | 64/87/98 | 0.3/3.6/16 |
| Conv UV cure | n.d.* | n.d.* | 78/88/99 |

IKEA R2 (after excimer cure)

| | | | |
|---|---|---|---|
| Water | 1 | 1 | 4 |
| Coffee | 5 | 5 | 5 |
| Red wine | 2 | 2 | 5 |
| Nail scratch | 2 | 2 | 3 |

*n.d. Conventional UV was not done because the gloss after excimer cure was already high

Table 8 shows that a certain amount of DPGDA is needed in combination with dispersed solution acrylics to obtain low gloss coatings after excimer cure. At this level of reactive diluent the resulting coatings shows improved chemical resistance and nail scratch resistance.

### Gloss Values of the Formulations of the Emulsion Polymers EP1 to EP14

TABLE 9
Gloss values of the emulsion polymers EP1 to EP14.

| Example | Ex7 | Ex8 | Ex9 | Ex10 | Ex11 | Ex12 | Ex13 |
|---|---|---|---|---|---|---|---|
| Formulation | F-EP1 | F-EP2 | F-EP3 | F-EP4 | F-EP5 | F-EP6 | F-EP7 |
| Reactive diluent | DPGDA | DPGDA | DPGDA | DPGDA | DPGDA | DPGDA | DPGDA |
| Amount (s/s) | 40% | 40% | 40% | 40% | 40% | 40% | 40% |

Gloss (GU20°/60°/85°)

| | | | | | | | |
|---|---|---|---|---|---|---|---|
| Excimer/UV | 0.1/1.1/12.6 | 0.2/2.8/6.9 | 0.1/1.0/3.4 | 0.5/4.8/10 | 0.5/4.8/14 | 2.6/18/58 | 0.3/3.9/17 |
| cure | | | | | | | |
| Conv UV cure | 87/92/96 | 12/49/79 | 87/92/98 | 76/85/98 | 91/98/99 | 75/87/98 | 95/100/100 |

| Example | Ex14 | Ex15 | Ex16 | Ex17 | CEx4 | Ex18 | Ex19 |
|---|---|---|---|---|---|---|---|
| Formulation | F-EP8 | F-EP9 | F-EP10 | F-EP11 | F-EP12 | F-EP13 | F-EP14 |
| Reactive diluent | DPGDA | DPGDA | DPGDA | DPGDA | DPGDA | DPGDA | DPGDA |
| Amount (s/s) | 40% | 40% | 40% | 40% | 40% | 40% | 40% |

Gloss (GU20°/60°/85°)

| | | | | | | | |
|---|---|---|---|---|---|---|---|
| Excimer/UV | 2/16/68 | 0.1/1.0/7.9 | 0.8/6.8/48 | 0.5/4.3/53 | 48/81/96 | 0.1/1.8/8.7 | 2/14/54 |
| cure | | | | | | | |
| Conv UV cure | 30/53/91 | 48/81/91 | 41/74/93 | 83/98/99 | 56/83/97 | 15/36/43 | 73/85/98 |

The results in Table 9 show that when the measured Tg of the emulsion polymer is >77° C. excimer cure in the presence of 40 wt % DPGDA does not result in a low gloss coating.

TABLE 10
Variation in the amount of reactive diluent in Neocryl XK-82.

| Example | CEx5 | CEx6 | Ex20 | Ex21 | Ex22 |
|---|---|---|---|---|---|
| Binder | XK-82 | XK-82 | XK-82 | XK-82 | XK-82 |
| Reactive | DPGDA | DPGDA | DPGDA | DPGDA | DPGDA |
| diluent | | | | | |
| Amount (s/s) | 0 | 20 | 30 | 40 | 60 |

Gloss (GU20°/60°/85°)

| | | | | | |
|---|---|---|---|---|---|
| Excimer/ | 65/91/100 | 66/91/100 | 0.5/5.8/66 | 0.3/3.5/27 | 0.1/0.9/11 |
| UV cure | | | | | |

Table 10 shows that 30 wt % DPGDA is needed to result in low gloss coatings after excimer cure. Lower amounts of reactive diluent do provide high gloss coatings.

TABLE 11
variation of the type of reactive diluent in EP9.

| Example | Ex23 | CEx7 | Ex24 |
|---|---|---|---|
| Binder | EP9 | EP9 | EP9 |
| Reactive | DPGDA | DPHA | GPTA |
| diluent | | | |
| Amount (s/s) | 40 | 40 | 40 |

Gloss (GU20°/60°/85°)

| | | | |
|---|---|---|---|
| Excimer cure | 0.1/1/7.9 | 23/59/62 | 0.3/3.4/36 |

Table 11 also shows that DPGDA and GPTA provide low gloss coatings after excimer cure whereas DPHA does not. Together with the data in Table 7 this shows that excimer cure can provide low gloss coatings when DPGDA (di-acrylate) or GPTA (tri-acrylate) are used but the use of higher acrylates like DPHA (hexa-acrylate) does not yield low gloss coatings.

The formulations listed in Table 6 F-EP8 and F-EP9 were mixed with 1.8% Acematt TS-100 to lower the gloss. These formulations were cured with UV cure without an inert atmosphere. See Table 12

TABLE 12
Comparison of the gloss values, stain resistances and nail scratch resistance of
binder dispersions EP8 and EP9 when matted with TS-100 when cured with Excimer.

| | Ex25 | CEx8 | Ex26 | CEx9 |
|---|---|---|---|---|
| Formulation | F-EP8 | F-EP8 + TS-100 | F-EP9 | F-EP9 + TS-100 |
| | Excimer/UV | Conv UV cure | Excimer/UV | Conv UV cure |
| | cure | | cure | |
| Gloss | 1.1/9.1/36 | 0.1/0.8/2.4 | 0.1/0.9/8.7 | 0.4/4.8/6.4 |
| (GU20/60°/85°) | | | | |
| | IKEA R0 | | | |
| Water (24 h) | 4 | 1 | 5 | 4 |
| Coffee (6 h) | 4 | 1 | 3 | 1 |
| | IKEA R2 | | | |
| Water (24 h) | 4 | 1 | 5 | 4 |
| Coffee (1 h) | 5 | 2 | 4 | 2 |
| Nail scratch | 5 | 2 | 4 | 2 |
| resistance | | | | |

Table 12 shows that coatings that have been cured with Excimer cure provide very low gloss coatings with good chemical resistance and nail scratch resistance. When the matting is achieved with TS-100 and curing done with regular UV curing the chemical resistances and nail scratch resistance are much worse compared to when matting and curing is done with Excimer.

### Comparative Experiments 10-16

A representative group of commercially available waterborne UV curable coating dispersions, as specified in Table 13, were applied on a Leneta card (2C Leneta Inc) using a 125 μm wire rod applicator. The coated cards were dried for 10 minutes in an oven with airspeed of 1.2 m/s at 50° C. Subsequently the so-obtained dried composition was cured using Conventional UV cure atmospheric and Excimer/UV cure as described above. The measured gloss values are reported in Table 13. The commercially available waterborne UV curable coating compositions as indicated in Table 13 have a different composition than the aqueous, radiation-curable coating composition of the present invention.

TABLE 13
Gloss values measured after conventional UV cure under
atmospheric conditions and combined Excimer/UV cure
of a representative group of commercially available
waterborne UV curable coating compositions

| | Conventional UV | | | | | |
|---|---|---|---|---|---|---|
| | Cure atmospheric | | | Excimer/UV cure | | |
| | GU | GU | GU | GU | GU | GU |
| | 20° | 60° | 85° | 20° | 60° | 85° |
| NeoRad ™ UV14 | 70 | 89 | 97 | 72 | 90 | 97 |
| NeoRad ™ R-520 | 78 | 93 | 99 | 80 | 93 | 99 |
| NeoRad ™ R-540 | 66 | 90 | 96 | 70 | 90 | 96 |
| Decovery ® SP-7100 | 71 | 92 | 98 | 65 | 91 | 97 |
| Bayhydrol ® UV 2280 | 82 | 95 | 99 | 81 | 94 | 99 |
| Bayhydrol ® UV 2282 | 29 | 64 | 69 | 30 | 66 | 72 |
| Bayhydrol ® eco UV 2877 | 69 | 91 | 98 | 72 | 92 | 97 |

Table 13 illustrates that the representative group of commercially available, waterborne UV curable dispersions, when subjected to Excimer/UV cure, do not result in matt coatings.

1. A process for producing a coating from an aqueous, radiation-curable coating composition, wherein the process comprises the steps in the sequence (1) to (4):
(1) applying an aqueous, radiation-curable coating composition on a surface of a substrate,
(2) drying the aqueous, radiation-curable coating composition, affording an at least partially dried coating composition,
(3) irradiating the at least partially dried coating composition with UV light having a wavelength≤220 nm under inert atmosphere, followed by
(4) irradiating with UV light having a wavelength≤300 nm or with E-beam, wherein the aqueous, radiation-curable coating composition is a dispersion comprising:
(A) at least one water-dispersed polymer system (A) of at least one vinyl polymer, wherein
the polymer system (A) comprises vinyl polymer with a glass transition temperature Tg of less than or equal to 77° C. in an amount of at least 50 wt. %, based on the amount of the polymer system (A), wherein the T_{g} is determined with Differential Scanning Calorimetry as described in the description, the polymer system (A) is essentially free of radiation-curable, ethylenically unsaturated bonds, and
the polymer system (A) has an acid value from 5 to 105 mg KOH/gram (A),
(B) at least one radiation-curable diluent (B) with a molar mass less than 750 g/mol and with an acrylate functionality of from 2 to 3, and
(C) water and optionally organic solvent, whereby the optional organic solvent is present in an amount of at most 30 wt. %, based on the total amount of water and organic solvent,
wherein the amount of (A) is from 30 to 75 wt. % and the amount of (B) is from 25 to 70 wt. %, based on the total amount of (A) and (B).

2. The process of claim 1, wherein the amount of vinyl polymer with a glass transition temperature T_{g} of at most 77° C. in the polymer system (A) is at least 55 wt. %, based on the amount of the polymer system (A).

3. The process of claim 1, wherein the polymer system (A) comprises at least two vinyl polymers with a T_{g} difference of at least 20° C., and at most 200° C.

4. The process of claim 1, wherein the polymer system (A) comprises
(A1) carboxylic acid functional olefinically unsaturated monomer, and
(A2) olefinically unsaturated monomer, different from (A1).

5. The process of claim 4, wherein
monomers (A1) are selected from the group consisting of itaconic acid, itaconic anhydride, mono-alkylesters of itaconic acid, mono-aryl esters of itaconic acid, acrylic acid, methacrylic acid, β-carboxyethyl acrylate and combinations thereof.

6. The process of claim 4, wherein at least 30 weight percent of the total amount of monomers (A2) is selected from the group consisting of methyl methacrylate, n-butyl acrylate, n-butyl methacrylate, 2-ethyl hexyl acrylate, 2-octyl acrylate, styrene and mixtures of two or more of said monomers.

7. The process of claim 1, wherein at least 50 wt. % of the radiation-curable diluents (B) is selected from the group consisting of:
di(trimethylolpropane) tri-acrylate (di-TMP3A) with the corresponding molecular formula C₂₁H₃₂O₈ and its corresponding molar mass of 412 g/mol, di(trimethylolpropane) tri-acrylate comprising alkoxy groups,
glyceryl propoxy triacrylate (GPTA) with the corresponding molecular formula C₂₁H₃₂O₉ and its corresponding molar mass of 428 g/mol,
glyceryl propoxy triacrylate comprising additional alkoxy groups, pentaerythritol tri-acrylate (PET3A) with the corresponding molecular formula C₁₄H₁₈O₇ and its corresponding molar mass of 298 g/mol,
pentaerythritol tri-acrylate comprising alkoxy groups, trimethylolpropane triacrylate (TMPTA) with the corresponding molecular formula C₁₅H₂₀O₆ and its corresponding molar mass of 296 g/mol, trimethylolpropane triacrylate comprising alkoxy groups,
dipropyleneglycol diacrylate (DPGDA) with the corresponding molecular formula C₁₂H₁₈O₅ and its corresponding molar mass of 242 g/mol,
dipropyleneglycol diacrylate comprising additional alkoxy groups, and any mixture thereof.

8. The process of claim 1, wherein the acrylate functionality of the at least one radiation-curable diluent (B) is 2.

9. The process of claim 1, wherein
the amount of (A) is from 35 to 75 wt. % and the amount of (B) is from 25 to 65 wt. %,
based on the entire weight of the aqueous, radiation-curable coating composition.

10. The process of claim 1, wherein
the amount of the optional organic solvent in the aqueous, radiation-curable coating composition is at most 2 wt. %, wherein the amount of organic solvent is given based on the total amount of water and organic solvent present in the aqueous, radiation-curable coating composition.

11. The process of claim 1, wherein the polymer system (A) has a radiation-curable, ethylenically unsaturated bond concentration of less than 0.50 milli-equivalents (meq) per g of (A).

12. The process of claim 1, wherein the polymer system (A) has a weight-average molecular weight M_{w} of at most 250,000 g/mol, wherein the weight-average molecular weight M_{w} is determined as described in the description.

13. The process of claim 1, wherein the z-average particle size of the dispersion consisting of (A), (B) and (C) is from 30 to 200 nm, whereby the z-average particle size is determined with the method as described in the description.

14. The process of claim 1, wherein the irradiating in step (3) is effected by ≥150 nm.

15. The process of claim 1, wherein UV irradiation is applied in step (4) and the aqueous, radiation-curable coating composition comprises one or more photo-initiators.

16. (canceled)

17. A coated substrate, wherein the coated substrate is obtained with the process of claim 1.

18. The process of claim 1, wherein the polymer system (A) comprises at least two vinyl polymers with a T_{g} difference of at least 60° C., and of at most 150° C.

19. The process of claim 4, wherein monomer (A1) is acrylic acid or methacrylic acid and monomers (A2) are selected from the group consisting of acrylates, methacrylates, arylalkylenes, itaconates and any mixture thereof.

20. The process of claim 1, wherein at least 70 wt. % of the radiation-curable diluents (B) is selected from the group consisting of:
di(trimethylolpropane) tri-acrylate (di-TMP3A) with the corresponding molecular formula C₂₁H₃₂O₈ and its corresponding molar mass of 412 g/mol, di(trimethylolpropane) tri-acrylate comprising alkoxy groups,
glyceryl propoxy triacrylate (GPTA) with the corresponding molecular formula C₂₁H₃₂O₉ and its corresponding molar mass of 428 g/mol,
glyceryl propoxy triacrylate comprising additional alkoxy groups, pentaerythritol tri-acrylate (PET3A) with the corresponding molecular formula C₁₄H₁₈O₇ and its corresponding molar mass of 298 g/mol,
pentaerythritol tri-acrylate comprising alkoxy groups, trimethylolpropane triacrylate (TMPTA) with the corresponding molecular formula C₁₅H₂₀O₆ and its corresponding molar mass of 296 g/mol, trimethylolpropane triacrylate comprising alkoxy groups,
dipropyleneglycol diacrylate (DPGDA) with the corresponding molecular formula C₁₂H₁₈O₅ and its corresponding molar mass of 242 g/mol,
dipropyleneglycol diacrylate comprising additional alkoxy groups, and any mixture thereof.

21. The process of claim 1, wherein at least 90 wt. % of the radiation-curable diluents (B) is selected from the group consisting of:
di(trimethylolpropane) tri-acrylate (di-TMP3A) with the corresponding molecular formula C₂₁H₃₂O₈ and its corresponding molar mass of 412 g/mol, di(trimethylolpropane) tri-acrylate comprising alkoxy groups,
glyceryl propoxy triacrylate (GPTA) with the corresponding molecular formula C₂₁H₃₂O₉ and its corresponding molar mass of 428 g/mol,
glyceryl propoxy triacrylate comprising additional alkoxy groups, pentaerythritol tri-acrylate (PET3A) with the corresponding molecular formula C₁₄H₁₈O₇ and its corresponding molar mass of 298 g/mol,
pentaerythritol tri-acrylate comprising alkoxy groups, trimethylolpropane triacrylate (TMPTA) with the corresponding molecular formula C₁₅H₂₀O₆ and its corresponding molar mass of 296 g/mol, trimethylolpropane triacrylate comprising alkoxy groups,
dipropyleneglycol diacrylate (DPGDA) with the corresponding molecular formula C₁₂H₁₈O₅ and its corresponding molar mass of 242 g/mol,
dipropyleneglycol diacrylate comprising additional alkoxy groups, and any mixture thereof.
